(19) United States
(12) Patent Application Publication
(10) Pub. No.: US 2006/0067315 A1
(43) Pub. Date: Mar. 30, 2006

(54) Building packets in a multi-protocol environment

(76) Inventors: Andrew Tan, Chandler, AZ (US); James Bury, Chandler, AZ (US)

Correspondence Address: FISH & RICHARDSON, PC, P.O. BOX 1022, MINNEAPOLIS, MN, 55440-1022, US

(21) Appl. No.: 10/955,931

(22) Filed: Sep. 30, 2004

(51) Int. Cl. H04L 12/28

(52) U.S. Cl. 370/389; 370/395.5

(57) ABSTRACT

Assembling packets includes determining portions of the packets in parallel. Determining portions of the packets in parallel includes determining a first header portion of the packets in parallel with determining a second header portion of the packets. Corresponding ones of the determined portions are combined to form the packets.

### BACKGROUND

This invention relates to packet processing in switched fabric networks.

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with or as a possible replacement for PCI in computer systems. The PCI Special Interest Group (PCI-SIG) manages PCI specifications (e.g., PCI Express Base Specification 1.0a) as open industry standards, and provides the specifications to its members.

Advanced Switching (AS) is a technology which is based on the PCI Express architecture, and which enables standardization of various backplane architectures. AS utilizes a packet-based transaction layer protocol that operates over the PCI Express physical and data link layers. The AS architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The Advanced Switching Interconnect Special Interest Group (ASI-SIG) is a collaborative trade organization chartered with providing a switching fabric interconnect standard, specifications of which it provides to its members.

### BRIEF DESCRIPTION OF THE DRAWINGS

FIG. 1 is a block diagram of a switched fabric network.

FIG. 2 is a diagram of protocol stacks.

FIG. 3 is a diagram of an AS transaction layer packet (TLP) format.

FIG. 4 is a diagram of an AS route header format.

FIG. 5 is a block diagram of an end point.

FIG. 6 is a block diagram of packet building module.

FIG. 7 is a block diagram of a multi-source header engine.

FIG. 8 is a timing diagram showing times of packet construction.

### DETAILED DESCRIPTION

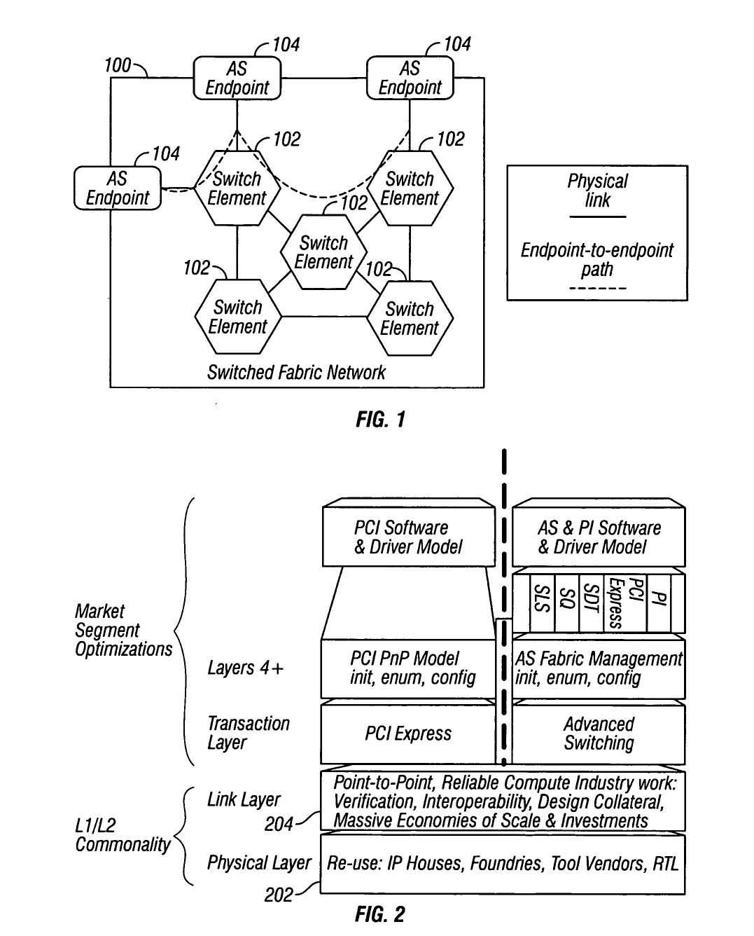

FIG. 1 shows a switched fabric network 100. The switched fabric network 100 includes switch elements 102 and end points 104. End points 104 can include any of a variety of types of hardware, e.g., CPU chipsets, network processors, digital signal processors, media access and/or host adaptors). The switch elements 102 constitute internal nodes of the switched fabric network 100 and provide interconnects with other switch elements 102 and end points 104. The end points 104 reside on the edge of the switched fabric network 100 and represent data ingress and egress points for the switched fabric network 100. The end points 104 are able to encapsulate and/or translate packets entering and exiting the switched fabric network 100 and may be viewed as “bridges” between the switched fabric network 100 and other interfaces (not shown) including other switched fabric networks.

Each switch element 102 and end point 104 has an Advanced Switching (AS) interface that is part of the AS architecture defined by the “Advance Switching Core Architecture Specification” (e.g., Revision 1.0, December 2003, available from the Advanced Switching Interconnect-SIG at www.asi-sig.org). The AS architecture utilizes a packet-based transaction layer protocol that operates over the PCI Express physical and data link layers 202, 204, as shown in FIG. 2.

In some implementations, the end points 104 include a packet building module that has the ability to assemble different portions (e.g., header or payload fields) of a packet (e.g., an AS transaction layer packet) in parallel. For example, different header fields may include information that can be determined independently for each of a series of packets being sent into the switched fabric network 100. For example, a header field indicating a route for a packet can be determined independently from a header field indicating a priority of the packet. Therefore, separate computing resources (e.g., dedicated circuitry and/or dedicated processor execution threads) can be dedicated to determining these header fields.

The fields can be concurrently constructed and stored in separate memory locations. This enables the dedicated computing resources to determine and store data for a second packet without waiting for all of the fields of a first packet to be constructed and stored. A packet assembly module can then assemble a packet after all of the fields are available. An exemplary packet building module is described in more detail below.

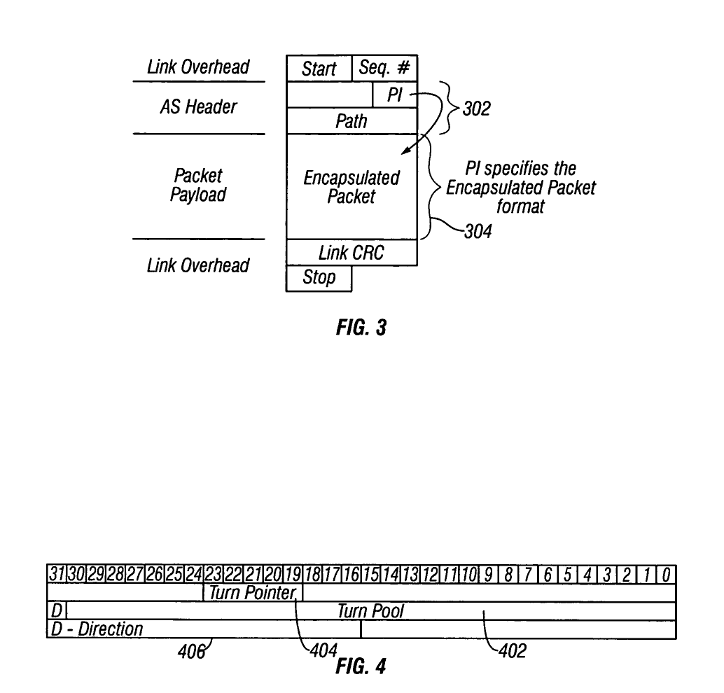

AS uses a path-defined routing methodology in which the source of a packet provides all information required by a switch (or switches) to route the packet to the desired destination. FIG. 3 shows an AS transaction layer packet (TLP) format 300. The TLP format 300 includes an AS header field 302 and a payload field 304. The AS header field 302 includes a Path field 302A (for “AS route header” data) that is used to route the packet through an AS fabric, and a Protocol Interface (PI) field 302B (for “PI header” data) that specifies the Protocol Interface of an encapsulated packet in the payload field 304. AS switches route packets using the information contained in the AS header 302 without necessarily requiring interpretation of the contents of the encapsulated packet in the payload field 304.

A path may be defined by the turn pool 402, turn pointer 404, and direction flag 406 in the AS header 302, as shown in FIG. 4. A packet's turn pointer indicates the position of the switch's “turn value” within the turn pool. When a packet is received, the switch may extract the packet's turn value using the turn pointer, the direction flag, and the switch's turn value bit width. The extracted turn value for the switch may then used to calculate the egress port.

The PI field 302B in the AS header 302 determines the format of the encapsulated packet in the payload field 304. The PI field 302B is inserted by the end point 104 that originates the AS packet and is used by the end point that terminates the packet to correctly interpret the packet contents. The separation of routing information from the remainder of the packet enables an AS fabric to tunnel packets of any protocol.

The PI field 302B includes a PI number that represents one of a variety of possible fabric management and/or application-level interfaces to the switched fabric network 100. Table 1 provides a list of PI numbers currently supported by the AS Specification.

TABLE 1
AS protocol encapsulation interfaces

| PI number | Protocol Encapsulation Identity (PEI) |
|---|---|
| 0 | Fabric Discovery |
| 1 | Multicasting |
| 2 | Congestion Management |
| 3 | Segmentation and Reassembly |
| 4 | Node Configuration Management |
| 5 | Fabric Event Notification |
| 6 | Reserved |
| 7 | Reserved |
| 8 | PCI-Express |
| 9-95 | ASI-SIG defined PEIs |
| 96-126 | Vendor-defined PEIs |
| 127 | Reserved |

PI numbers 0-7 are used for various fabric management tasks, and PI numbers 8-126 are application-level interfaces. As shown in Table 1, PI number 8 (or equivalently “PI-8”) is used to tunnel or encapsulate a native PCI Express packet. Other PI numbers may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS architecture supports the establishment of direct endpoint-to-endpoint logical paths through the switch fabric known as Virtual Channels (VCs). This enables a single switched fabric network to service multiple, independent logical interconnects simultaneously, each VC interconnecting AS end points for control, management and data. Each VC provides its own queue so that blocking in one VC does not cause blocking in another. Each VC may have independent packet ordering requirements, and therefore each VC can be scheduled without dependencies on the other VCs.

The AS architecture defines three VC types: Bypass Capable Unicast (BVC); Ordered-Only Unicast (OVC); and Multicast (MVC). BVCs have bypass capability, which may be necessary for deadlock free tunneling of some, typically load/store, protocols. OVCs are single queue unicast VCs, which are suitable for message oriented “push” traffic. MVCs are single queue VCs for multicast “push” traffic.

The AS architecture provides a number of congestion management techniques, one of which is a credit-based flow control technique that ensures that packets are not lost due to congestion. Link partners (e.g., an end point 104 and a switch element 102, or two switch elements 102) in the network exchange flow control credit information to guarantee that the receiving end of a link has the capacity to accept packets. Flow control credits are computed on a VC-basis by the receiving end of the link and communicated to the transmitting end of the link. Typically, packets are transmitted only when there are enough credits available for a particular VC to carry the packet. Upon sending a packet, the transmitting end of the link debits its available credit account by an amount of flow control credits that reflects the packet size. As the receiving end of the link processes the received packet (e.g., forwards the packet to an end point 104), space is made available on the corresponding VC. Flow control credits are then returned to the transmission end of the link. The transmission end of the link then adds the flow control credits to its credit account.

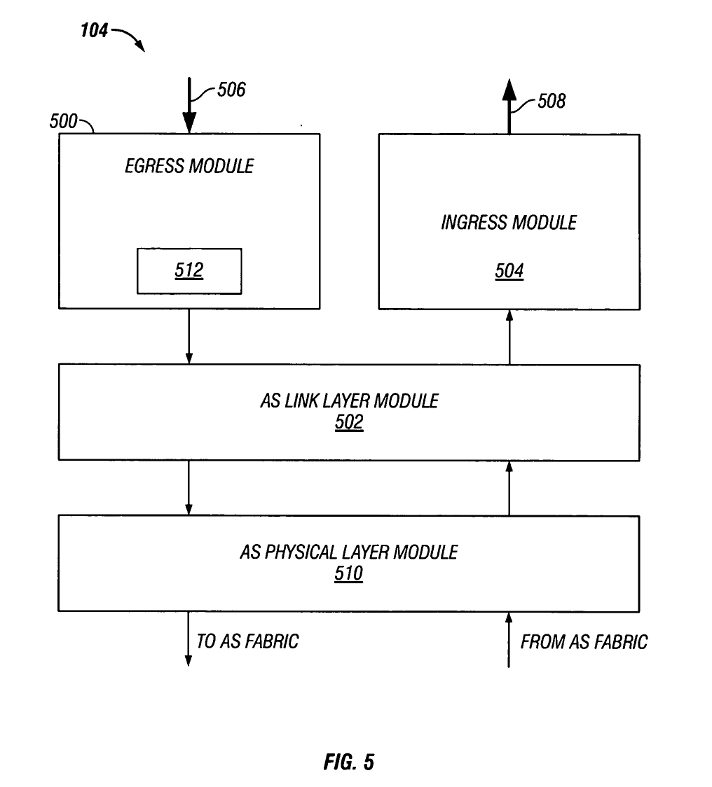

FIG. 5 shows a block diagram of functional modules in an implementation of an end point 104. The end point 104 includes an egress module 500 for transmitting data into the switched fabric network 100 via an AS link layer module 502. The end point also includes an ingress module 504 for receiving data from the switched fabric network 100 via the AS link layer module 502. The egress module 500 implements various AS transaction layer functions including building AS transaction layer packets, some of which include encapsulated packets received over an egress interface 506. The ingress module 504 also implements various AS transaction layer functions including extracting encapsulated packets that have traversed the switched fabric network 100 to send over an ingress interface 508. The AS link layer module 502 is in communication with an AS physical layer module 510 that handles transmission and reception of data to and from a neighboring switch element 102 (not shown).

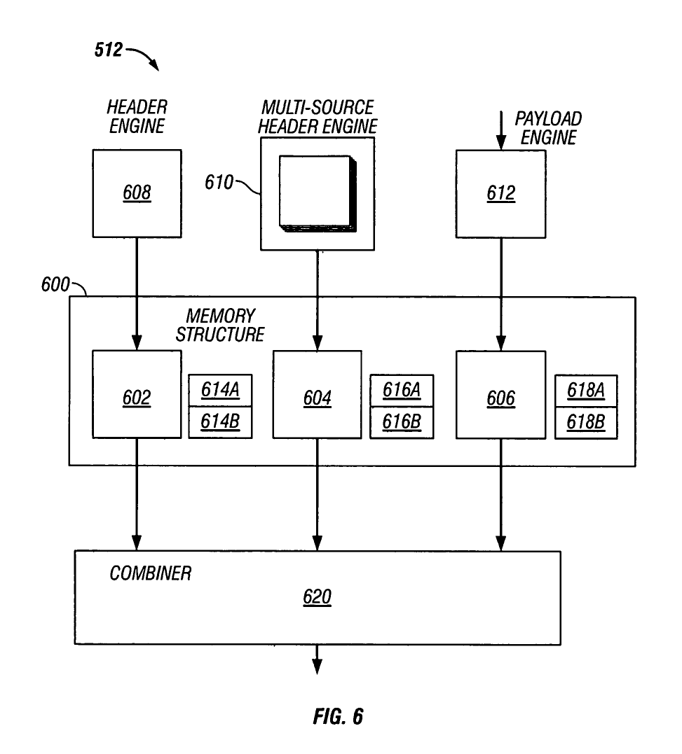

The egress module 500 includes a packet building module 512 that assembles AS transaction layer packets to be sent into the switched fabric network 100. FIG. 6 shows a block diagram of an implementation of a packet building module 512. A segmented memory structure 600 includes separate memory areas 602, 604 and 606 (e.g., separate memory devices or separate address spaces in a common memory device) that can each be used as a staging area for constructing respective portions of a series of packets. In this example, the segmented memory structure 600 has three memory areas. Other implementations can have more or fewer memory areas.

Any of a variety of types of data sources can provide the portions of a packet to be stored in one of the memory areas. In at least some implementations, each data source is able to operate independently from the other data sources. A data source can be implemented using software (e.g., as a dedicated execution thread in a processor), using hardware (e.g., as dedicated circuitry), or using both software and hardware. The example in FIG. 6 includes three data sources. The first memory area 602 receives AS route header data for a Path field 302A from a header engine 608. The second memory area 604 receives PI header data (including a PI number) for a PI field 302B from a multi-source header engine 610. The third memory area 606 receives payload data for a payload field 304 from a payload engine 612. The payload engine 612 optionally fetches a packet to be encapsulated in the packet being built. Optionally, some packets may include only a subset of these fields (e.g., a “control packet” that does not include payload data).

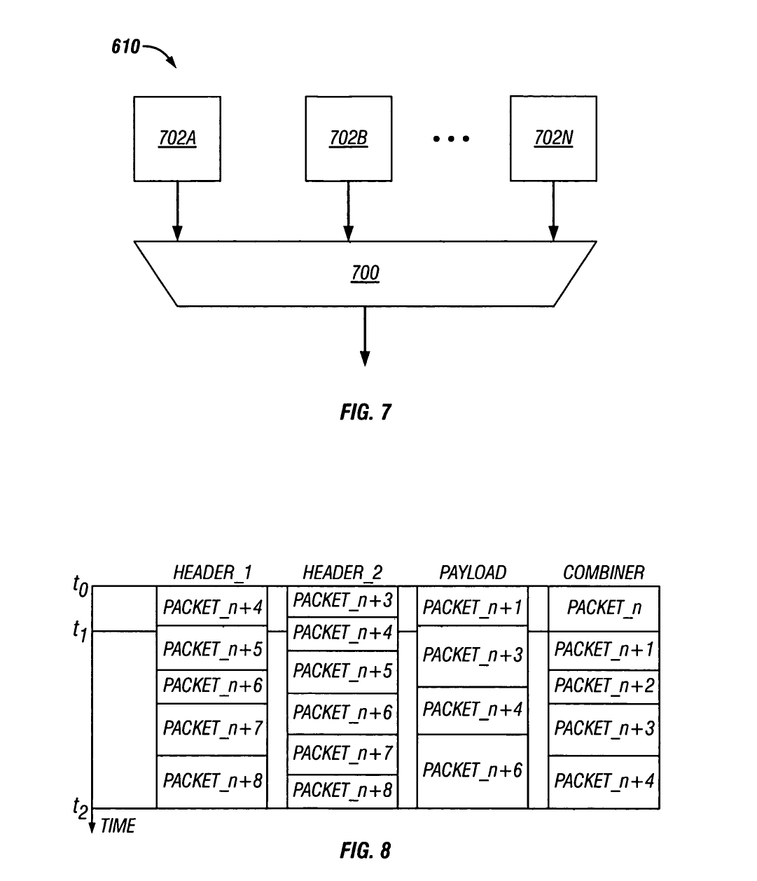

In one implementation, the multi-source header engine 610 includes multiple customized PI modules that each handles a particular PI or group of PIs. FIG. 7 shows an implementation of the multi-source header engine 610 that includes a multiplexer 700 and multiple PI modules 702A-702N. This enables a scalable architecture that allows PI modules to be added or removed as needed without affecting the other data sources.

Each data source is able to operate in parallel and independently of the other data sources. For example when the header engine 608 is building the AS route header, the multi-source header engine 610 can be building the PI header and the payload engine 612 can be fetching payload data concurrently. Once a particular data source is done with its current work that data source can start building the corresponding portion for the next packet even though the current packet might not be completely build yet.

The packet building module 512 includes a combiner 620 that assembles corresponding portions of a packet stored in the segmented memory structure 600. The combiner 620 monitors the status of packets in the segmented memory structure 600, and after the portions of a packet are stored in their respective memory areas, the combiner 620 assembles the portions of the packet to form a packet that is ready to be sent out (e.g., to the AS link layer module 502).

In one implementation, the segmented memory structure 600 includes two indicators associated with each memory area that are used by the combiner 620 to monitor the status of packets. For example, the first memory area 602 is associated with a first indicator 614A that is used to reserve space for a portion of a particular packet in the memory area 602 when the corresponding (one or more) portions of the packet are being built and stored in the other memory areas. A second indicator 614B is used to notify the combiner 620 that a particular portion of a packet is built and stored.

These two indicators can be used to build various kinds of AS packets. For example, if a packet only includes an AS route header and a PI header and no payload, then only space in the first memory area 602 and the second memory area 604 of the segmented memory structure 600 are reserved for that packet. After the AS route header portion and PI header portion are built and stored, the corresponding indicators notify the combiner 620 to assemble that packet. Since only the AS route header portion and PI header portion had space reserved for packet data, the combiner is notified that for that particular packet there is no need to wait for payload data to be fetched and stored.

FIG. 8 shows example timelines showing when different fields are being constructed with respect to one another and with respect to when they are combined. The header engine 608 is working on a field header_1 for a series of packets packet_n+4 to packet_n+9 from time t₀ to time t₂. The multi-source header engine 610 is working on a field header_2 for a series of packets packet_n+3 to packet_n+8 from time t₀ to time t₂. The payload engine 612 is working on a field payload for a series of packets packet_n+1 to packet_n+6 from time t₀ to time t₂. The combiner 620 is assembling the packets packet_n to packet_n+4 from time t₀ to time t₂. At time t₁ the combiner 620 transitions from working on packet_n to working on packet_n+1 since data for the fields header_1, header_2, and payload have finished being constructed and have been stored for packet_n+1. Not all of the packets (e.g., packet_n+2 and packet_n+5) have a payload field, so the payload engine 612 does not need to fetch payload data for these packets. At any particular time (e.g., time t₁) the engines are not necessarily constructing portions of any particular packet concurrently. At some times, (e.g., time t₂) the engines may be constructing portions of a packet concurrently (e.g., header_1 and header_2 are being constructed concurrently at time t₂ for packet_n+8 ).

The techniques described in this specification can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Processes described herein can be performed by one or more programmable processors executing a computer program to perform functions described herein by operating on input data and generating output. Processes can also be performed by, and techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of these techniques, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method for assembling packets, comprising:
determining portions of the packets in parallel, including determining a first header portion of the packets in parallel with determining a second header portion of the packets; and
combining corresponding of the determined portions to form the packets.

2. The method of claim 1, wherein each of the portions of a packet comprises data associated with a corresponding field defined by a packet format.

3. The method of claim 2, wherein the packet format conforms to an Advanced Switching protocol.

4. The method of claim 1, wherein determining portions of the packets in parallel comprises determining a first portion of the packets independently of determining a second portion of the packets.

5. The method of claim 1, wherein determining portions of the packets in parallel comprises determining a first portion of the packets and a second portion of the packets using separate computing resources.

6. The method of claim 5, wherein the separate computing resources comprise separate circuits.

7. The method of claim 5, wherein the separate computing resources comprise separate execution threads.

8. The method of claim 5, wherein the separate computing resources comprise separate memory areas.

9. The method of claim 8, wherein the separate memory areas comprise separate address spaces in a memory device.

10. The method of claim 8, wherein the separate memory areas comprise separate memory devices.

11. The method of claim 8, further comprising reserving space in a first of the separate memory areas for the first portion of a first packet and reserving space in a second of the separate memory areas for the second portion of the first packet.

12. The method of claim 11, further comprising combining portions including the first and second portions to form a packet after any reserved space for the portions to be combined has been filled.

13. The method of claim 1, wherein determining portions of the packets in parallel comprises determining a first portion of the packets concurrently with determining a second portion of the packets.

14. The method of claim 13, further comprising:
storing data representing the first portion of a first packet; and
after storing the data representing the first portion of the first packet, storing data representing a first portion of a second packet prior to storing data representing a second portion of the first packet.

15. The method of claim 1, wherein determining the first header portion of each of at least some of the packets comprises selecting data from one of a plurality data sources.

16. The method of claim 1, wherein determining the first header portion of each of at least some of the packets comprises determining a protocol interface associated with an encapsulated packet.

17. The method of claim 16, wherein the protocol interface corresponds to an Advanced Switching Protocol Interface.

18. The method of claim 1, wherein determining the first header portion of each of at least some of the packets comprises determining a route associated with the corresponding packet.

19. The method of claim 1, wherein determining one of the portions of each of at least some of the packets comprises determining a payload.

20. The method of claim 19, wherein determining the payload comprises fetching the payload from a memory area.

21. The method of claim 19, wherein determining the payload comprises encapsulating a packet into the payload.

22. The method of claim 1, wherein determining the portions of each of at least some of the packets comprises determining a header field and a payload field.

23. The method of claim 1, wherein the first and second header portions comprise at least two of the group consisting of:
a route;
a protocol interface identifier;
a source; and
a destination.

24. The method of claim 1, further comprising adding a portion to at least some of the assembled packets.

25. The method of claim 24, wherein the added portion includes a cyclic redundancy check.

26. An apparatus for assembling packets, comprising:
a plurality of data sources for determining the portions of the packets in parallel, including a first data source to determine a first header portion of the packets in parallel with a second data source to determine a second header portion of the packets; and
a combiner in communication with each of the data sources for combining corresponding of the determined portions to form the packets.

27. The apparatus of claim 26, wherein each of the portions of a packet comprises data associated with a corresponding field defined by a packet format.

28. The apparatus of claim 27, wherein the packet format conforms to an Advanced Switching protocol.

29. A system for assembling packets, comprising:
a switched fabric network; and
a device coupled to the network including:
a plurality of data sources for determining the portions of the packets in parallel, including a first data source to determine a first header portion of the packets in parallel with a second data source to determine a second header portion of the packets; and
a combiner in communication with each of the data sources for combining corresponding of the determined portions to form the packets.

30. The system of claim 29, wherein each of the portions of a packet comprises data associated with a corresponding field defined by a packet format.

31. The system of claim 30, wherein the packet format conforms to an Advanced Switching protocol.
